(19) United States
(12) Patent Application Publication
(10) Pub. No.: US 2006/0261134 A1
(43) Pub. Date: Nov. 23, 2006

(54) Nanopowder synthesis method

(75) Inventor: Chi-Chuang Ho, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/432,970

(22) Filed: May 12, 2006

(30) Foreign Application Priority Data
May 20, 2005 (CN) 200510034747.X

(51) Int. Cl. A47J 36/02

(52) U.S. Cl. 228/101

(57) ABSTRACT

A nanopowders synthesis method includes: providing a water phase reactant and an oil phase reactant; and stirring the water phase reactant and the oil phase reactant to form a microemulsion with dispersed phases of the water phase reactant and the oil phase reactant whereby nanopowders are formed via reaction of the water phase reactant and the oil phase reactant in the microemulsion.

### TECHNICAL FIELD

The present invention relates to nanopowder synthesis methods, and more particularly to a nanopowder synthesis method using a microemulsion method.

### BACKGROUND

Nanomaterials can be divided into four categories as nanopowders, nanofibers, nanofilms and nanoblocks. Nanofilms and nanoblocks are generally formed from nanopowders. Therefore, the synthesis of nanopowders is very important: Synthesis techniques for nanopowders can be generally divided into vapor deposition methods and liquid deposition methods. Vapor deposition methods can be used to form high-purity nanopowders. However, vapor deposition methods have relatively low productivity and require high energy consumption, and are therefore seldom used. Liquid deposition methods include precipitation reaction methods, Sol-Gel methods, water-heating methods, and microemulsion methods. Among liquid deposition methods, microemulsion methods are perhaps most widely used. Microemulsion methods have the advantage of being simple in the structure of their apparatus, easy to operate, having controllable grain size, and being capable of continuous manufacture.

Microemulsions generally consist of the following four constituents: a surfactant, a cosurfactant (for example a fatty alcohol), an organic solvent such as alkane or cyclanes, and water. Nanoscale structures of the microemulsion (i.e. dispersed phases) are substantially utilized. Especially in a water-in-oil microemulsion system, metallic slats can be dissolved in water phases and form fine water pools covered with surfactant and oil phases. Nanopowders can be thereby formed in the water pools via deposition reactions.

However, during the formation of the microemulsion of water and oil, a surfactant is generally required. The surfactant itself can affect the performance of the microemulsion, which results in low productivity of reactions thereof

What is needed, therefore, is a nanopowder synthesis method which can synthesize nanopowders with high productivity.

### SUMMARY

In a preferred embodiment, a nanopowder synthesis method includes the steps of: providing a water phase reactant and an oil phase reactant; and stirring the water phase reactant and the oil phase reactant to form a microemulsion with dispersed phases of the water phase reactant and the oil phase reactant whereby nanopowders are formed via reaction of the water phase reactant and the oil phase reactant in the microemulsion.

Other advantages and novel features will become more apparent from the following detailed description when taken in conjunction with the accompanying drawings, in which:

### BRIEF DESCRIPTION OF THE DRAWINGS

Many aspects of the present method for synthesizing nanopowders can be better understood with reference to the following drawings. The components in the drawings are not necessarily to scale, the emphasis instead being placed upon clearly illustrating the principles of the present method. Moreover, in the drawings, like reference numerals designate corresponding parts throughout the several views.

FIG. 1 is a schematic flow chart of a method for synthesizing nanopowders in accordance with a preferred embodiment; and

FIG. 2 is a schematic view of a reaction apparatus used in the method of FIG. 1.

The exemplifications set out herein illustrate at least one preferred embodiment, in one form, and such exemplifications are not to be construed as limiting the scope of the present method for synthesizing nanopowders in any manner.

### DETAILED DESCRIPTION OF PREFERRED EMBODIMENTS

Embodiments of the present invention will now be described in detail below and with reference to the drawings.

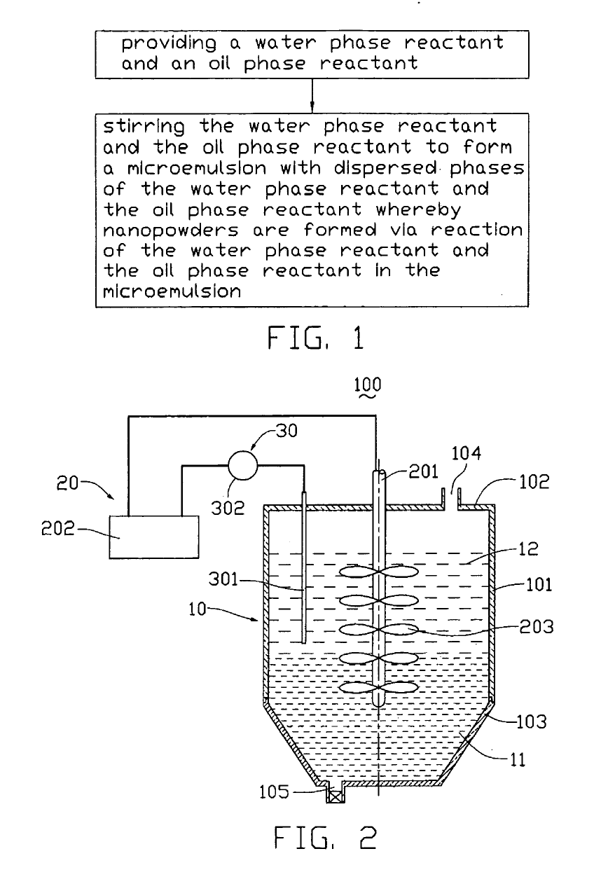

Referring to FIG. 1, a nanopowder synthesis method according to a preferred embodiment is provided. The method comprises the steps of:
(1) providing a water phase reactant and an oil phase reactant; and
(2) stirring the water phase reactant and the oil phase reactant to form a microemulsion with dispersed phases of the water phase reactant and the oil phase reactant whereby nanopowders are formed via reaction of the water phase reactant and the oil phase reactant in the microemulsion.

Referring to FIG. 2, the nanopowder synthesis method in accordance with the preferred embodiment is described in detail below including references to various embodiments thereof

In step (1) water phase reactant 11 and an oil phase reactant 12 are provided. The water phase reactant 11 can be selected from the group comprising a lithium salt solution, a lithium complex, and any water solution containing lithium ions. The oil phase reactant 12 may be a solution of an organic cobalt compound. The water phase reactant 11 and the oil phase reactant 12 are provided in predetermined proportion, for example, 1:1 by volume. In the preferred embodiment, the water phase reactant 11 employs a lithium salt solution, and the oil phase reactant 12 employs a solution of organic cobalt compound.

In step (2) the water phase reactant 11 and the oil phase reactant 12 in a reaction apparatus 100 are stirred to form a microemulsion with dispersed phases of the water phase reactant 11 and the oil phase reactant 12 whereby nanopowders are formed via reaction of the water phase reactant 11 and the oil phase reactant 12 in the microemulsion. The reaction apparatus 100 comprises a reaction chamber 10 and a stirring device 20. The reaction chamber 10 comprises a body portion 101, an inlet portion 102 having an inlet 104, and an outlet portion 103 having an outlet 105. The stirring device 20 comprises an operation portion 201 and a control portion 202. The operation portion 201 is fixed to the inlet portion 102 and comprises a blade stirrer 203 extending into the body portion 101 of the reaction chamber 10. The blade stirrer 203 is rotatable about the operation portion 201. Preferably, the blade stirrer 203 is located at the center of the reaction chamber 10. The water phase reactant 11 and the oil phase reactant 12 are filled into the body portion 101 of the reaction chamber 10 via the inlet 104. In the reaction chamber 10, the water phase reactant 11 and the oil phase reactant 12 separate from each other and form two layers. In the preferred embodiment, the layer of the lithium salt solution is located near the outlet portion 103 of the reaction chamber 10, and the layer of the solution of organic cobalt compound is located near the inlet portion 102 of the reaction chamber 10. Operating the stirring device 20 to stir the water phase reactant 11 and the oil phase reactant 12 by the blade stirrer 203. The operating speed of the blade stirrer 203 is no lower than 10000 RPM (revolutions per minute). Furthermore, in the mixing step, the operating speed, the stirring direction, and the position of the blade stirrer 203 can be adjusted by the control portion 202 of the stirring device 20. Due to the high-speed stirring, a water-in-oil microemulsion with dispersed phases of the water phase reactant 11 and the oil phase reactant 12 is formed. Thereby nanopowders of lithium cobalt oxide can be formed by reacting the lithium salt solution and the organic cobalt compound in the dispersed phases of the microemulsion. The nanopowder can then be collected from the outlet 105 of the outlet portion 103 of the reaction chamber 10.

In addition, the present nanopowder synthesis method may further comprise controlling the reaction temperature. The reaction apparatus 100 may further comprise a temperature detecting device 30. The temperature detecting device 30 comprises a temperature sensor 301 extending into the body portion 101 of the reaction chamber 10 and a signal transfer portion 302 electrically connected with the control portion 202 of the stirring device 20. The temperature sensor 301 is configured for detecting the temperature of the reactants and providing a corresponding temperature signal. The signal transfer portion 302 is configured for sending the temperature signal to the control portion 202 of the stirring device 20. The control portion 202 may adjust the reaction temperature of the reactants, responding to the temperature signal by adjusting the speed of the blade stirrer 203. In operating this apparatus, a preferred temperature (i.e., the temperature required by the highest conversion ratio of the reaction) is set and the temperature sensor 301 is kept in touch with the reactants, and the reaction temperature is controlled to ensure the reaction is performed at the preferred temperature.

As stated above, the nanopowder synthesis method in accordance with a preferred embodiment forms the microemulsion by high-speed stirring of the water phase reactant 11 and the oil phase reactant 12. Therefore, a surfactant is not necessary, and consequent side effects thereof can be avoided. In addition, the reaction temperature is controllable, thus ensuring that the reactants can be fully used.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A nanopowder synthesis method comprising the steps of:
providing a water phase reactant and an oil phase reactant; and
stirring the water phase reactant and the oil phase reactant to form a microemulsion with dispersed phases of the water phase reactant and the oil phase reactant whereby nanopowders are formed via reaction of the water phase reactant and the oil phase reactant in the microemulsion.

2. The nanopowder synthesis method in accordance with claim 1, wherein the water phase reactant is selected from a group comprising a lithium salt solution, a lithium complex, and any water solution containing lithium ions.

3. The nanopowder synthesis method in accordance with claim 1, wherein the oil phase reactant is a solution of an organic cobalt compound.

4. The nanopowder synthesis method in accordance with claim 1, wherein the water phase reactant and the oil phase reactant are provided in predetermined proportion.

5. The nanopowder synthesis method in accordance with claim 4, wherein the predetermined proportion is 1:1 by volume.

6. The nanopowder synthesis method in accordance with claim 1, wherein the stirring is performed by a blade stirrer.

7. The nanopowder synthesis method in accordance with claim 6, wherein an operating speed of the blade stirrer is no lower than 10000 RPM.

8. The nanopowder synthesis method in accordance with claim 6, wherein the operating speed of the stirring is controllable.

9. The nanopowder synthesis method in accordance with claim 6, wherein the reaction temperature is controllable by adjusting operating speed of the blade stirrer.

10. The nanopowder synthesis method in accordance with claim 9, wherein the reaction temperature is detected by a temperature sensor.
